(19) United States
(12) Patent Application Publication
(10) Pub. No.: US 2023/0302967 A1
(43) Pub. Date: Sep. 28, 2023

(54) VEHICLE SEAT

(71) Applicant: Dr. Ing. h.c. F. Porsche Aktiengesellschaft, Stuttgart (DE)

(72) Inventor: Jan Bela, Sachsenheim (DE)

(21) Appl. No.: 18/121,217

(22) Filed: Mar. 14, 2023

(30) Foreign Application Priority Data
Mar. 28, 2022 (DE) 10 2022 107 289.4

(51) Int. Cl. B60N 2/20; B60N 2/01

(52) U.S. Cl. CPC B60N 2/206; B60N 2/01

(57) ABSTRACT

A vehicle seat (20) has a first seat base (21), a first backrest (22), a first hinge assembly (31) defining a first axis of rotation (41), and a second hinge assembly (32) defining a second axis of rotation (42). The first backrest (22) is rotatable via the first hinge assembly (31) and via the second hinge assembly (32) relative to the seat base (22). The second axis of rotation (42) is spaced apart from the first axis of rotation (41). The first backrest (22) extends between a top end (112) and a bottom end (111) in a first spatial situation (P1) provided for driving.

### CROSS-REFERENCE TO RELATED APPLICATION

This application claims priority on German Patent Application No 10 2022 107 289.4 filed Mar. 28, 2022, the entire disclosure of which is incorporated herein by reference.

### BACKGROUND

Field of the Invention. The invention relates to a vehicle seat, a vehicle seat assembly, and a vehicle.

Related Art DE 10 2013 007 184 B1, JP S58-78233 U, JP S57-85332 U, and JP H08-183378 A all disclose motor vehicle seats having a seat base, a backrest, and a flap provided in the backrest.

JP S54-181418 U, FR 2 944 740 A1, and FR 2 944 745 B1 all disclose seats in which a backrest can be pivoted rearwardly with the upper part.

The invention relates to a new vehicle seat and a vehicle with such a seat.

### SUMMARY OF THE INVENTION

A vehicle seat comprises a first seat base, a first backrest and first and second hinge assemblies. The first hinge assembly defines a first axis of rotation, and the second hinge assembly defines a second axis of rotation that is spaced from the first axis of rotation. The first backrest is rotatable via the first hinge assembly and via the second hinge assembly relative to the seat base. The first backrest extends between a top end and a bottom end in a first spatial situation provided for driving.

The entire backrest can be rotated via both the first hinge assembly and the second hinge assembly in a manner that allows an advantageous spatial situation for a person located behind the vehicle seat.

In some embodiments, the second hinge assembly is arranged higher than the first hinge assembly to allow for a different relative rotation.

In a first spatial situation, the bottom end is arranged at a first height, the top end is arranged at a second height, and the second hinge assembly is located at a third height that is between the first height and the second height. As a result, a portion of the backrest can be rotated forward and a portion of the backrest can be rotated rearward.

The first height may be defined in percentage as 0%, the second height may be defined in percentage as 100%, and the third height may be in a first range that is between 20% and 100%, preferably between 25% and 80%, and further preferably between 30% and 70%. Thus, the second hinge assembly is not all the way down or all the way up.

In some embodiments, the first seat base has a highest seat base position and the first axis of rotation defined by the first hinge assembly is below the highest seat base position. This allows for a good adjustability of the spatial situation desired for driving.

In some embodiments, the second axis of rotation is defined by the second hinge assembly and is above the highest seat base position. The second axis of rotation may be at least 20 cm above the highest seat base position, and preferably at least 30 cm above the highest seat base position. This provides sufficient space for stretching out the legs.

The vehicle seat of some embodiments has at least one sidewall, and the second hinge assembly is configured at the at least one sidewall. Thus, the sidewall allows for a good rotatability of the entire rear surface.

The first hinge assembly is configured on the at least one sidewall. The sidewall can thereby act structurally on both the first hinge assembly and the second hinge assembly.

According to some embodiments, the sidewall is rotatable by the first hinge assembly relative to the first seat base. The sidewall can thereby rotate along with the first hinge assembly and thus remains in the correct position for the second hinge assembly.

The first backrest of some embodiments is rotatable via the second hinge assembly into a second spatial situation. The second spatial situation may be configured, at least in regions, to define a first height spacing between the first seat base and the first backrest of at least 10 cm, preferably at least 15 cm, further preferably at least 20 cm, and particularly preferably at least 30 cm. This allows a leg to be stretched out for a semi-seated body position.

The first height spacing everywhere may be at least 10 cm, preferably at least 15 cm, further preferably at least 20 cm, and particularly preferably at least 30 cm. This first height spacing provides a well-suited space for the legs.

In some embodiments, the first backrest that is in the first spatial situation has a rear side, and the first backrest is rotatable via the second hinge assembly into a third spatial situation, in which the rear side is arranged on top. The third spatial situation corresponds to the second spatial situation. The rear side can be harder and more level than the front side, and therefore is better suited as a table or shelf.

The first backrest of some embodiments may have a flat surface on the rear side and may be rotatable via the second hinge assembly into a fourth spatial situation where the flat surface of the rear side is arranged horizontally at least in sections on the top side of the backrest. This is advantageous, for example, so that a laptop does not slide down from the rear side when the vehicle is stationary.

The first backrest may comprise a storage area having a depression, and the depression may extend down in the fourth spatial situation. The recess, for example, is suitable for storing a cup securely.

At least one of the first and second hinge assemblies may comprise a pivot bearing.

A headrest may be attached to the backrest so that the headrest can be rotated as the backrest rotates.

In some embodiments, the first backrest is rotatable as a whole via the first hinge assembly and via the second hinge assembly relative to the seat base.

According to some embodiments, the first backrest is rotatable from the first spatial situation via the second hinge arrangement relative to the seat base in such a way that the top end has a frontward motion portion and the bottom end has a rearward motion portion. The upper region is thus moved forward by the rotation, and the rear side is moved upward.

A vehicle seat assembly according to the invention comprises the above-described first vehicle seat and a second vehicle seat. The second vehicle seat comprises a second seat base and a second backrest and is arranged behind the first vehicle seat. As a result, a person in the second vehicle seat can utilize the first vehicle seat.

The spacing of the first vehicle seat relative to the second vehicle seat can be predefined. Thus, a person in the vehicle seat can set a comfortable position, and the backrest of the first vehicle seat can be brought into a suitable position as a table or shelf.

The spacing of the first seat base from the second seat base may be adjustable to a distance of less than 30 cm, preferably less than 20 cm, and particularly preferably less than 10 cm. Thus, a largely continuous support of the legs can be established.

The invention also relates to vehicle that comprises that comprises the above-described vehicle seat assembly. The vehicle can be used for resting to increase safety.

The invention further relates to a vehicle that comprises a windshield. The vehicle also has a first headrest associated with the first backrest and a second headrest associated with the second backrest. The first backrest may be rotatable via the second hinge assembly into a fourth spatial situation in such a way that, looking from the second vehicle seat at the height of the second headrest, the windshield is not obstructed by the first backrest. Thus, a person in the second seat can enjoy a view or watch a film in a vehicle cinema system from behind. The fourth spatial situation may correspond to the second spatial situation and/or the third spatial situation.

Further details and advantages of the invention will emerge from the embodiments described below and illustrated in the drawings, which are not to be construed as limiting the invention in any way. The features mentioned above and discussed below can be used in the respectively specified combination and also in other combinations or on their own, without departing the scope of the invention.

### BRIEF DESCRIPTION OF THE DRAWINGS

FIG. 1 is a schematic side view of a vehicle having a vehicle seat assembly in a first spatial situation

FIG. 2 is a schematic side view of the vehicle of FIG. 1 with the vehicle seat assembly in a second spatial situation.

FIG. 3 is a schematic view of a vehicle seat shown in FIG. 1.

FIG. 4 is a schematically view from the rear of the vehicle seat of FIG. 2 in the second spatial situation.

### DETAILED DESCRIPTION

Parts that are the same or have the same effect bear the same reference numerals in the following and are generally described only once. The descriptions of all of the figures build on one another to avoid unnecessary repetitions.

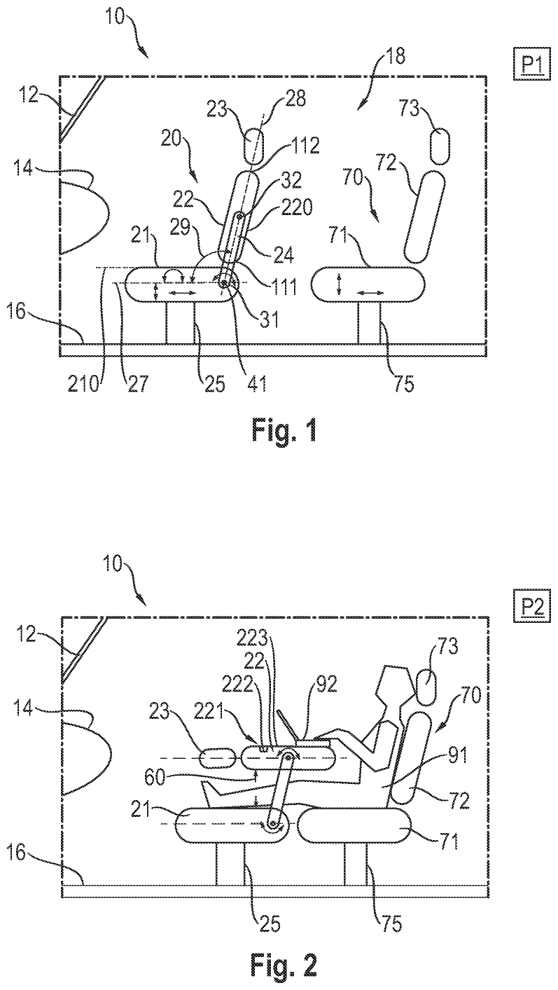

FIG. 1 schematically shows a vehicle 10 having a vehicle seat assembly 18, a windshield, and/or front screen 12, a dashboard 14, and a vehicle floor 16. The vehicle seat assembly 18 comprises vehicle seats 20 and 70 arranged one behind the other.

The vehicle seat 20 has a seat base 21, a backrest 22, a headrest 23, a hinge assembly 31, and a hinge assembly 32. The seat base 21 typically is upholstered, but can be configured as a plastic shell.

The vehicle seat 70 has a seat base 71, a backrest 72, and a headrest 73.

The hinge assembly 31 defines an axis of rotation 41, and the hinge assembly 32 defines an axis of rotation 42.

The hinge assemblies 31, 32 can be configured as pure pivot bearings. However, they can also have a folding assembly that allows a translational displacement in addition to the rotation so that the axis of rotation changes position during the rotation. Such folding assemblies comprise, for example, multiple hinge rods and/or a pivot bearing. The hinge assemblies 31, 32 can have a detent for predefined detent positions.

The backrest 22 is rotatable via the first hinge assembly 31 and the second hinge assembly 32 relative to the seat base 22. The two axes of rotation 41, 42 are spaced apart from one another.

A sidewall 24 and a further sidewall (not shown) on the opposite side of the backrest 22 are provided.

The hinge assembly 32 is on the sidewalls 24, and the hinge assembly 31 also is on the sidewall 24.

The sidewall 24 is rotatable by the hinge assembly 31 relative to the seat base 21. However, the position of the sidewall 24 remains unchanged upon rotation of the backrest 22 via the hinge assembly 32 relative to the seat base 21.

An adjustment assembly 25 is provided for adjusting the vehicle seat 20, and an adjustment assembly 75 is provided for adjusting the vehicle seat 70. The adjustment options include, for example, at least one of the adjustment options from the group consisting of: a height adjustment of the seat base 21; a tilting movement of the seat base 21; a sliding of the seat base 21 forward or backward; a rotational movement about the hinge assembly 31; and a rotational movement about the hinge assembly 32.

The hinge assembly 32 is higher than the hinge assembly 31, and this results in a different relative movement, in which the upper region of the seat base 22 can simultaneously be folded forward and the lower region of the seat base 22 can be folded rearward, or vice versa.

The hinge assembly 32 also can be configured to limit the possible range of rotation angles.

The first seat base 21 has a highest seat base position 210, the height of which is indicated by a dashed line. The hinge assembly 31 preferably is below the highest seat base position 210, and the hinge assembly 32 preferably is arranged above the highest seat base position 210, further preferably at least 20 cm above the highest seat base position 210, and particularly preferably at least 30 cm above the highest seat base position 210.

In the illustrated embodiment, the backrest 22 is in a first spatial situation P1 for travel and extends in a direction indicated by a dashed line 28. The seat base 21 extends in a direction indicated by a dashed line 27 that preferably is substantially horizontal. The angle 29 between the lines 27 and 28 in the spatial situation P1 preferably is greater than 90°. Preferably, the vehicle seat 20 may be for the passenger or for the driver. In the spatial situation P1, an occupant on the vehicle seat 70 can only partially see the windshield 12, because the field of view is at least partially obstructed by the vehicle seat 20. The backrest 22 has a rear side 220 that faces the vehicle seat 70.

In the vehicle seat assembly 18, the spacing of the vehicle seat 20 relative to the vehicle seat 70 can be variably predefined, for example, by a displacement of the vehicle seat 20, by a displacement of the vehicle seat 70, or by a displacement of the vehicle seat 20 and the vehicle seat 70.

The spacing of the first seat base 21 from the second seat base 71 is adjustable such that it is less than 30 cm, preferably less than 20 cm, and particularly preferably less than 10 cm.

FIG. 2 shows, in a view corresponding to FIG. 1, the vehicle 10 having the vehicle seat assembly 18. Unlike the spatial situation P1 of FIG. 1, the vehicle seat assembly 18 of FIG. 2 has assumed a spatial situation P2. Here, the backrest 22 has been rotated via the second hinge assembly 32, and the rear side 220 has a horizontal orientation, at least in regions. In addition, the seat bases 21 and 71 have been moved towards one another, and this allows an occupant 91 seated on the vehicle seat 70 to take a comfortable position, where the legs can be stretched out between the seat base 21 and the backrest 22. The occupant 91 can thus conveniently place his or her legs on the front seat base 21. In addition, the rotated backrest 22 provides a shelf surface and can be used as a table. In the embodiment of FIG. 2, the occupant 91 works on a laptop 92 that lies on the backrest 22. Utilizing the rear side 220 of the backrest 22 is advantageous, because it can be level at least in regions without affecting seating comfort.

In the embodiment of FIG. 2, the backrest 22 comprises a storage area 221 having a recess 222 on the rear side 220. In the spatial situation P2, the recess 222 extends down and can be used, for example, to position a cup or other object.

The occupant 91 seated on the second vehicle seat 70 with his or her head at the height of the headrest 73 can see the windshield 12 without being obscured by the backrest 22 or the headrest 23 by rotating the entire backrest 22 into spatial situation P2.

A height spacing 60 between the seat base 21 and the backrest 22 may be at least 10 cm, preferably at least 15 cm, further preferably at least 20 cm, and particularly preferably at least 30 cm. As a result, the legs of the occupant 91 seated in the vehicle seat 70 can be stretched comfortably out between the seat base 21 and the backrest 22. Preferably, the height spacing 60 everywhere is at least 10 cm, preferably at least 15 cm, further preferably at least 20 cm, and particularly preferably at least 30 cm. The height spacing is the distance in the z-direction of the vehicle, i.e. perpendicularly upward.

In the illustrated embodiment, the sidewalls 24 allow the entire backrest 22 to be rotated about the hinge assembly 31 as well as about the hinge assembly 32.

Alternatively, the hinge assembly 32 can be a pin or another type of pivot bearing (not shown) on the B-pillar or at another location on the vehicle body.

The spacing between the seat bases 21 and 71 can also be chosen so that the occupant can lower his or her legs.

In the illustrated embodiment, the backrest 22 has a flat surface 223 on the rear side 220. The backrest 22 is rotatable via the second hinge assembly 32 into the spatial situation P2 where the flat surface 223 is arranged horizontally at least in sections on the top side of the backrest 22.

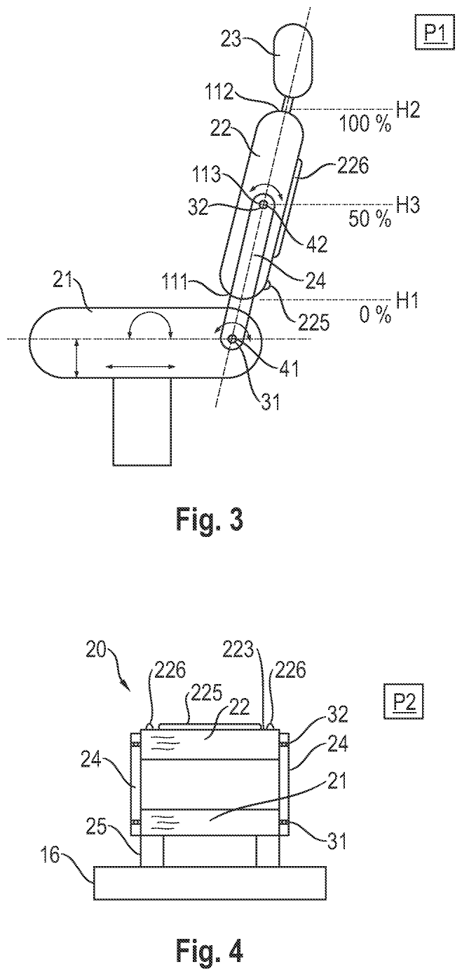

FIG. 3 shows the vehicle seat 20 in an enlarged view. The spatial situation corresponds to the spatial situation P1 of FIG. 1.

The backrest 22 has a bottom end 111 and a top end 112, and extends between the bottom end 111 and the top end 112. The bottom end 111 is at a first height H1, the top end 112 is at a second height H2, and the hinge assembly 32 is at a third height H3. The third height H3 is between the first height H1 and the second height H2.

The first height H1 can be defined in percentage as 0%, the second height H2 as 100%, and the third height H3 is in a range between 20% and 100%, preferably between 25% and 80%, and further preferably between 30% and 70%. In the illustrated embodiment, the third height H3 is at approximately 50%.

In the illustrated embodiment, lateral stops 226 and a bottom stop 225 are arranged on the rear of the backrest 22. These reduce the risk that objects will slide down from the backrest 22 in the spatial situation P2. The stops 225, 226 can be steps or rounded protrusions. They can also be countersunk to prevent a disturbance of the occupant seated behind them in the spatial situation P1.

FIG. 4 shows the vehicle seat 20 of FIG. 1 and FIG. 2 in the spatial situation P2. The clearance between the seat base 21 and the backrest 22 can be seen.

The stops 226 and 225 are positioned, as shown, to allow for a secure placement of objects on the backrest 22 even when the surface 223 is arranged in non-level orientation. The stops 226, 225 can also be provided around the outer edge of the backrest 22.

Many variants and modifications are possible within the scope of the invention.

1. A vehicle seat (20), comprising: a first seat base (21), a first backrest (22), a first hinge assembly (31) defining a first axis of rotation (41) and a second hinge assembly (32) defining a second axis of rotation (42) that is spaced from the first axis of rotation (41), the first backrest (22) being rotatable via the first hinge assembly (31) and via the second hinge assembly (32) relative to the seat base (22), the first backrest (22) extending between a top end (112) and a bottom end (111) in a first spatial situation (P1) for driving.

2. The vehicle seat (20) of claim 1, wherein the second hinge assembly (32) is higher than the first hinge assembly (31).

3. The vehicle seat (20) of claim 1, wherein, in the first spatial situation (P1): the bottom end (111) is at a first height (H1), the top end is at a second height (H2), and the second hinge assembly (32) is between the first height (H1) and the second height (H2).

4. The vehicle seat (20) of claim 3, wherein the first height (H1) is defined in percentage as 0%, the second height (H2) is defined in percentage as 100%, and the third height (H3) is in a first range of between 20% and 100%.

5. The vehicle seat (20) of claim 1, wherein the first seat (21) has an upper surface defining a highest seat base position (210), and the first axis of rotation (41) is below the highest seat base position (210).

6. The vehicle seat (20) of claim 6, wherein the second axis of rotation (42) defined by the second hinge assembly (32) is at least 20 cm above the highest seat base position (210).

7. The vehicle seat (20) of claim 1, further comprising at least one sidewall (24) and the second hinge assembly (32) being on the at least one sidewall (24).

8. The vehicle seat (20) of claim 7, wherein the first hinge assembly (31) is on the at least one sidewall (24).

9. The vehicle seat (20) of claim 8, wherein the sidewall (24) is rotatable by the first hinge assembly (31) relative to the first seat base (21).

10. The vehicle seat (20) of claim 1, wherein the first backrest (22) is rotatable via the second hinge assembly (32) into a second spatial situation (P2) where the first backrest (22) is spaced above the first seat base (21) by a first height spacing (60) of at least 10 cm.

11. The vehicle seat (20) of claim 1, in which the first backrest (22) comprises a rear side (220) in the first spatial situation (P1), and the first backrest (22) being rotatable via the second hinge assembly (32) into a third spatial situation (P2) in which the rear side (220) is arranged on top.

12. The vehicle seat (20) of claim 11, wherein the first backrest (22) has a flat surface (223) on the rear side (220) and is rotatable via the second hinge assembly (32) into a fourth spatial situation (P2), in which the flat surface (223) of the rear side (220) is arranged at least in sections horizontally on a top side of the backrest (22).

13. The vehicle seat (20) of claim 12, wherein the first backrest (22) comprises a storage area (221) having a depression (222) that extends downwardly in the fourth spatial situation (P2).

14. The vehicle seat (20) of claim 1, wherein at least one of the first hinge assembly (31) and the second hinge assembly (32) comprise a pivot bearing.

15. The vehicle seat (20) of claim 1, wherein the first backrest (22) is rotatable from the first spatial situation (P1) via the second hinge assembly (32) relative to the seat base (22) in such a way that the top end (112) has a forward motion portion and the bottom end (111) has a rearward motion portion.

16. A vehicle seat assembly (18) comprising the first vehicle seat (20) of claim 1, and a second vehicle seat (70) with a second seat base (71) and a second backrest (72), the second vehicle seat (70) being arranged behind the first vehicle seat (20).

17. The vehicle seat assembly (18) of claim 16, wherein a spacing of the first vehicle seat (20) from the second vehicle seat (70) is variable.

18. The vehicle seat assembly (18) of claim 17, wherein the spacing of the first seat base (21) from the second seat base (71) is adjustable to a dimension of less than less than 30 cm.

19. A vehicle (10) comprising the vehicle seat assembly (18) of claim 16.

20. The vehicle (10) of claim 19, comprising a windshield (12), a first headrest (23) associated with the first backrest and a second headrest (73) associated with the second backrest (72), and the first backrest (22) being rotatable via the second hinge assembly (32) into a fourth spatial situation (P2) such that, looking from the second vehicle seat (70) at a height of the second headrest (73), the windshield (12) is not obstructed by the first backrest (22).
